(19) United States
(12) Patent Application Publication
(10) Pub. No.: US 2014/0269218 A1
(43) Pub. Date: Sep. 18, 2014

(54) Watch Engaged ATIS Reminder Systems

(71) Applicant: Jeffrey Herold, Huntington Beach, CA (US)

(72) Inventor: Jeffrey Herold, Huntington Beach, CA (US)

(21) Appl. No.: 14/217,076

(22) Filed: Mar. 17, 2014

Related U.S. Application Data
(60) Provisional application No. 61/799,421, filed on Mar. 15, 2013.

(51) Int. Cl. G04B 45/00

(52) U.S. Cl. CPC G04B 45/0092
USPC 368/10

(57) ABSTRACT

A wristwatch-engaged ATIS letter designation device and method is provided for employment by users to provide a visual reminder of a designated letter chosen earlier from a group including a plurality of said letters. The system, being wristwatch worn and easily activated, provides an easy way to remember letter designations for subsequent recall minutes or hours later.

This application claims priority to U.S. Provisional Patent Application Ser. No. 61/799,421 filed on Mar. 15, 2013, and incorporated herein in its entirety by this reference thereto.

### BACKGROUND OF THE INVENTION

1. Field of the Invention

The present invention relates to piloting of airplanes and the Automatic Terminal Information Service,(ATIS) system employed by pilots to familiarize themselves with the weather and airport conditions at an airport for an upcoming landing. More particularly, it relates to a device to allow pilots to easily designate and remember a letter designation for an ATIS report.

2. Prior Art

The Automatic Terminal Information Service, or ATIS, is a continuous broadcast of recorded local conditions and aeronautical information in busier airports. The ongoing ATIS broadcasts contain essential information, such as weather information, which runways at a particular airport are active, what airport approaches are available at a given airport, and any other information required by the pilots, to approach, land, and traverse the runways and pathways at an airport after landing. ATIS broadcasts also may contain “A Notice to Airmen” (NOTAM or NoTAM) information. Such information is a notice filed with an aviation authority to alert aircraft pilots of potential hazards along a flight route or at a destination location that could affect the safety of the flight. NOTAMs are created and transmitted by government agencies and airport operators.

Commercial and non commercial pilots usually listen to an available ATIS broadcast, before arrival at a destination airport and before contacting the local air control unit. This is done by conscience pilots to be aware of flight and ground conditions in advance, and in order to reduce the controllers' workload and relieve frequency congestion.

The ATIS recording is updated in fixed intervals or when there is a significant change in the information, like a change in the active runway at a given airport. The ATIS for a given airport, and each sequential update, is given a letter designation (e.g. “B” bravo), from the ICAO spelling alphabet. The letter progresses down the alphabet with every update, and starts again at Alpha “A” after a break in service of 12 hours or more.

When contacting the local control unit, a pilot who wishes to inform the local controllers that the pilot is on top of current ATIS information, will indicate he/she has “information” and the ATIS identification letter which designated the ATIS broadcast for the destination airport which was listened to, for example “A.” This is to let the controller know that the pilot is up to date with all current information.

A problem can arise with the system however when the pilot cannot remember the alphabet designation of the ATIS report that was reviewed by the pilot. Forgetting the ATIS letter can frequently happen because the pilot will frequently listen to the ATIS report for the next airport, which may be hours away, while the pilot is at or leaving the take-off airport. This problem can be increased where a pilot such as a commercial pilot makes numerous take-offs and landings every day, and thereby listens to numerous ATIS reports, at different times of the day before flying to the next airport destination. With multiple landings and multiple ATIS reports, and/or multi-hour flights subsequent to listening to the ATIS report for an upcoming airport, it can be easy to forget the alphabet letter for the ATIS report which a pilot dutifully reviewed. The result being the pilot cannot confirm to ground control upon landing, that in fact the pilot is aware of ground and air conditions at the airport of destination.

In the past pilots have written the letters on their hands, which is messy, can smear or come off entirely, and when there are multiple landings every day this can get confusing with multiple letters on the hands. Another mode of remembering is to write the letter for the ATIS report for an upcoming airport on a post it note, or slip of paper. However both are easily lost in a crowded busy cockpit.

As such their exists an unmet need, for an ATIS letter designation remembering system and device. Such a device should allow a pilot an easy means to remember the ATIS letter for a report on an upcoming airport for landing. Such a device should be simple and fast to use, and should not become lost easily over the day. Such a device should ideally be employable in combination with tools or clothing already used by pilots in order not to require them to buy another device, which might get lost and costs money.

### SUMMARY OF THE INVENTION

The ATIS report letter designation remembering system herein employs and easy to use, not easily lost, device which allows a pilot to listen to an ATIS report for a destination airport, and place a copy of the letter designator for that report, which the pilot will need on landing, on the pilot's person where it is easily read. The device herein provides a rotating wheel or bezel which is engaged to a wrist watch, which allows one-handed designation of an ATIS letter, in a manner that is secure, and will not get lost, and will be easily read during the landing procedure.

In one mode, the rotating wheel or bezel has the entire alphabet of letters employed for ATIS reports, in a sequential pattern spaced around the circumference of the wheel. The wheel or bezel rotates in two directions, and has a ratchet or other holding device which allows the user to rotate the wheel to the letter of the report just listened to, and simply look at their wrist when landing to ascertain the letter needed to indicate to ground control knowledge of the ATIS for the upcoming airport.

In a second mode, which would be most helpful for pilots who wear glasses to read, or operate frequently in a dim cabin, the letters are statically positioned on a stationary bezel in the circle sequential pattern. A rotating bezel or cover, rotates in two directions, and has 1 window formed in the cover with a magnification lens therein. The user rotates the cover until the window reveals the letter of the ATIS report just listened to, and the letter remains in the window until the cover is again rotated. While just an opening or non magnification glass would work and are anticipated, using high quality magnification lens material and a high contrast background, will make the letter placed in the window easy to see in dim light or if the pilot wears reading glasses. Additionally, an LED or other light may be added to illuminate the letter from the side or backlit to make it exceptionally visible. The light may be stitched on or off by pushing on the rotating cover toward the wrist to close a switch.

In a third mode of the device, the cover with the glass or magnifying window is stationary, and the user rotates an engaged wheel underneath until the letter of choice appears in the window. This mode would be preferred by those users who like to view the letter in the same position on the watch each time. This mode too may be backlit or side-lit as noted above.

### BRIEF DESCRIPTION OF DRAWING FIGURES

FIG. 1 shows the first mode of the wristwatch engaged ATIS letter designation system showing the ATIS letters placed sequentially on a bezel or wheel which rotates both directions and has an ATIS designator to designate a letter.

FIG. 2 shows another preferred mode of the wristwatch engaged ATIS letter designation system showing the rotating cover having a viewing window which may be rotated to display a chosen ATIS letters placed sequentially underneath in fixed positions.

FIG. 3 shows another preferred mode of the wristwatch engaged ATIS letter designation system, showing the device with a cover in a fixed in position, all the time, and a winder is employed to rotate rotating letter designators into the fixed position.

FIG. 4 shows another mode of a fixed position for the ATIS letter designator and a secondary winder to rotate the letters to position the correct one adjacent the designator.

### DETAILED DESCRIPTION OF THE PREFERRED EMBODIMENTS OF THE INVENTION

Referring now to the figures, FIG. 1 shows the first mode of the wristwatch engaged ATIS letter designation system showing the device 10 engaged with a wristwatch as are all modes of the device herein. In this mode, the ATIS designation letters 14 are placed sequentially on a bezel or wheel 12 which using the user's fingers, or a secondary winder 17 (FIG. 4) rotates both directions “R.” Also operatively positioned on the watch in all modes, is an ATIS designator 16 which is used by the user to designate a letter 14 by placing the two in a position where the letter 14 of choice is adjacent the ATIS designator 16. In different modes this may be done differently such as in FIG. 1, by rotating the wheel 12 with the fingers or if gear-engaged a secondary winder 17, to move either direction to position the letter 14 of choice adjacent to the ATIS designator 16.

FIG. 2 shows another preferred mode of the wristwatch engaged ATIS letter 14 designation system showing the device 10 having a rotating cover 12 having an ATIS designator which is a window 16. The window designator 16, may be rotated by moving the wheel 12 to which it engages, to display a chosen ATIS letters 14 which is operatively placed in an annular listing of the letters 14 sequentially, underneath the rotating cover 12 in fixed positions.

The window 14 may be open, may have plastic or glass therein, or in a particularly preferred mode, may have magnification glass therein to increase the letter 14 size to the view of the user which would be advantageous if they wear reading glasses or the cockpit is dim. A light (not shown but well known) can be placed to illuminate the window 16 and letter 14 from the side, or in a backlit manner which would substantially increase the ability to see the letter 14 in the dark or dim light.

FIG. 3 shows another preferred mode of the wristwatch engaged ATIS letter 14 designation system showing the device 10 having a cover 13 which is fixed in position, thereby fixing the ATIS designator in the form of window 16 in the same fixed type position which may be preferred by some users so they need not search on the face of their watch for the position of the day of the designator.

A tab 18 may be employed by the user to rotate an underlying wheel having the letters 14 sequentially placed on a surface, may be rotated by the tab 18 to rotate the chosen ATIS letter 14 into view in the window 16. Or a secondary winder 17 operatively engaged with the annular ring carrying the letters 14 may be employed to rotate the letter 14 into position.

This mode allows a fixed position for the ATIS designator in the form of a viewable window 16, and a means to maintain a familiar position to view for the letter 14 for the user. The same type of glass or magnification glass and lights as noted for the device of FIG. 2, may also be employed with this mode of the device 10 and allow users more ease of viewing the letter 14 in adverse light or where they cannot find reading glasses.

FIG. 4 shows the device 10 with an annular ring or wheel 12 carrying all of the ATIS letters 14. In this mode the ATIS designator is in a fixed position and the wheel 12 is rotatable by turning a secondary winder 17 which when rotated rotates the wheel 12 and thus the letters 14 to a position adjacent the ATIS designator.

FIG. 4 depicts a mode of the device 10 wherein the annular ring or wheel 12 bearing the indica showing the ATIS letters 14 is protected behind the lens of the watch. It is positioned such that when rotated by the secondary winder 17, the letter 14 of choice may easily and quickly be rotated to a position adjacent the ATIS designator 16 in the short amount of time allowed pilots for such an action. The secondary winder 17 is engaged by gears or other means to allow rotation of the wheel 12 with a rotation of the secondary winder 17.

As such all modes of the device 10 herein provide a quick and easily employed means for the user to designate an AGIS letter in the short time available for such, in a manner where it is easily read and recovered at a later time.

While all of the fundamental characteristics and features of the ATIS letter remembrance system have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A wristwatch-engaged ATIS letter designation apparatus, comprising:
means for positioning a single alphanumeric letter from a group including a plurality of said alphanumeric letters, in an adjacent position to a designator position, whereby a user may render said single alphanumeric letter a designated letter by achievement of said adjacent position; and
said single alphanumeric letter in said adjacent position defining a viewable reminder to said user at a later time of an identity of said designated letter.

2. The wristwatch-engaged ATIS letter designation apparatus of claim 1, wherein said means for positioning an alphanumeric letter in said adjacent position to a designator position comprises:
means to rotate one of, said plurality of said alphanumeric letters in sequential positions in said group, or said designator position, to thereby place said single alphanumeric letter in said adjacent position to said designator position.

3. The wristwatch-engaged ATIS letter designation apparatus of claim 1, additionally comprising:
said plurality of alphanumeric letters in said group, positioned in sequential positions around a planar ring;
said ring rotatable around the exterior circumference of the face of said watch, to thereby position a said single alphanumeric letter in said adjacent position next to said designator position.

4. The wristwatch-engaged ATIS letter designation apparatus of claim 1, additionally comprising:
said plurality of alphanumeric letters in said group, positioned sequentially around a planar ring surrounding said watch face;
a secondary ring covering said planar ring and said plurality of alphanumeric letters positioned thereon;
an aperture formed in said secondary ring;
said secondary ring in a rotational engagement with said watch; and
rotation of said secondary ring to position said aperture to surround an individual said letter from said plurality of letters in said group, thereby placing said individual letter in said designator position.

5. The wristwatch-engaged ATIS letter designation apparatus of claim 1, additionally comprising:
said plurality of alphanumeric letters in said group, positioned in sequential positions around a planar ring;
said planar ring rotatable around an exterior circumference of the face of said watch;
a secondary ring in a fixed position covering said plurality of alphanumeric letters in said group;
said secondary ring having a aperture therein in a fixed position on said watch;
said planar ring rotatable to position said single alphanumeric letter from a group within said aperture and in said adjacent position to a designator position, whereby a user can always look to the same position on the watch face, to certain said designated letter.
